(19) United States
(12) Patent Application Publication
(10) Pub. No.: US 2022/0315488 A1
(43) Pub. Date: Oct. 6, 2022

(54) COATED NONWOVEN MAT WITH TUNED PERFORMANCE PROPERTIES

(71) Applicant: Owens Corning Intellectual Capital, LLC, Toledo, OH (US)

(72) Inventors: Jianhui Wu, Westerville, OH (US); Allegra Flohr, Westerville, OH (US); Merideth Cooper-Steiger, Westerville, OH (US); Daryl Wernette, Alexandria, OH (US)

(21) Appl. No.: 17/713,555

(22) Filed: Apr. 5, 2022

Related U.S. Application Data
(60) Provisional application No. 63/171,117, filed on Apr. 6, 2021.

(51) Int. Cl. C04B 20/00; C04B 24/42; C04B 26/06; C04B 20/10

(52) U.S. Cl. CPC C04B 20/0048; C04B 24/42; C04B 26/06; C04B 20/1007; C04B 2103/0052

(57) ABSTRACT

A coated nonwoven mat includes a nonwoven base layer and a coating layer. The nonwoven base layer is formed from a plurality of fibers held together by a binder and includes a first surface and a second surface. The coating layer includes a coating composition comprising a binder component, a filler, and one or more performance modifiers. The coated nonwoven mat has an average Gurley porosity of at least 10 seconds and an average hydrostatic head performance of at least 10 mbar.

### CROSS-REFERENCE TO RELATED APPLICATION(S)

This application claims priority to and any benefit of U.S. Provisional Application No. 63/171,117, filed Apr. 6, 2022, the content of which is incorporated herein by reference in its entirety

### FIELD

The general inventive concepts relate to nonwoven fibrous mats and, more particularly, to coated nonwoven fibrous mats that include a coating layer comprising performance modifiers.

### BACKGROUND

Conventional glass fibers are useful in a variety of applications including reinforcements, building materials, textiles, and acoustical and thermal insulation materials. Nonwoven mats may be made from the fibers by conventional wet-laid processes, wherein wet chopped fibers are dispersed in a water slurry that contains surfactants, viscosity modifiers, defoaming agents, and/or other chemical agents. The slurry containing the fibers is delivered onto a moving screen where a substantial portion of the water is removed, leaving behind a web comprising the fibers and the various chemical agents in the slurry adhered to the fibers. A binder is then applied to the web, and the resulting mat is dried to remove any remaining water and cure the binder. The formed nonwoven mat is an assembly of dispersed, individual chopped fibers.

The binder composition works as an adhesive to bind the fibers together to form a cohesive product, while also improving the product's properties, such as form recovery, stiffness, acoustical openness, porosity, and structure.

Wall boards, such as gypsum or foam composite board panels, are used in building construction to form the partitions or walls of rooms, hallways, ceilings, and the like. Similar boards are also used in exterior wall or roof construction, such as sheathing or roof deck. Such composite boards may include facing or back mats, such as fiberglass or other woven or nonwoven mats, on one or both faces to enhance the performance properties of the board, such as board strength, rigidity, weather durability, and moisture or mold resistance. Such woven or nonwoven mats may be manufactured in-line with the wall board or independently thereof.

Conventional nonwoven mats generally have a porous structure such that materials, particularly liquid materials, applied to the nonwoven mats tend to bleed through from one surface of the nonwoven mat to the opposing surface of the nonwoven mat. Various solutions have been attempted to combat bleed through, including the use of coating layers applied onto the nonwoven mats.

Lightweight products that efficiently seal off the barrier between environment and underlying board are desirable. Conventional coating compositions include various formulations that typically include mineral pigments, organic binder, and fillers. Although such coating compositions are useful in manufacturing coated mats with various acceptable properties, such as Gurley porosity, it remains desirable to provide a coating composition capable of providing a coating layer with a more uniform water resistance that eliminates bleed though, while maintaining sufficient performance properties.

### SUMMARY

A coated nonwoven mat is described herein, and in accordance with various embodiments, may include a nonwoven base layer and a coating layer. The nonwoven base layer is formed from a plurality of fibers held together by a binder and includes a first surface and a second surface. The coating layer includes a coating composition including a binder component, a filler, and one or more performance modifiers. In certain embodiments, the coated nonwoven mat has an average Gurley porosity of at least 10 seconds and an average hydrostatic head performance of at least 10 mbar.

In certain embodiments, the coating composition includes a binder component in an amount from 2% to 20% by weight. In certain embodiments, the coating composition includes a filler in an amount from 65% to 99% by weight. In certain embodiments, the coating composition includes one or more performance modifiers in an amount from 0.05% to about 5.0% by weight. In certain embodiments, the performance modifier includes a hydrophobic additive. In certain embodiments, the performance modifier includes at least one of a silicone, a siloxane, and a wax. In certain embodiments, the performance modifier includes a polymethylhydrogen siloxane fluid. In certain embodiments, the coating composition includes 0.2% to 2.0% by weight of the performance modifier.

In certain embodiments, the coated nonwoven mat has an average hydrostatic head performance of between 10 mbar to 50 mbar. In certain embodiments, the nonwoven base layer has an uncoated basis weight of 65 g/m² to 75 g/m². In certain embodiments, the coated nonwoven mat includes a basis weight of 50 g/m² to 200 g/m². In certain embodiments, the coated nonwoven mat includes an average Gurley porosity of at least 100 seconds. In certain embodiments, the fibers include glass fibers. In certain embodiments, a gypsum board having at least one facer is provided, wherein the at least one facer includes a coated nonwoven mat according to any of the embodiments herein. In certain embodiments, a polyisocyanurate foam board having at least one facer is provided, wherein the at least one facer includes a coated nonwoven mat according to any of the embodiments herein.

In certain embodiments, a method of making a coated nonwoven mat is provided. The method can include providing a nonwoven base layer having a first surface and a second surface, applying a coating composition to the first surface of the nonwoven base layer to form a coating layer on the nonwoven base layer, and heating the coated nonwoven mat to form the coated nonwoven mat. The coating layer includes a coating composition including a binder component, a filler, and one or more performance modifiers. In certain embodiments, the coated nonwoven mat has an average Gurley porosity of at least 10 seconds and an average hydrostatic head performance of at least 10 mbar.

In certain embodiments, the coating composition includes a binder component in an amount from 2% to 20% by weight. In certain embodiments, the coating composition includes a filler in an amount from 65% to 99% by weight. In certain embodiments, the coating composition includes one or more performance modifiers in an amount from 0.05% to about 5.0% by weight. In certain embodiments, the performance modifier includes a hydrophobic additive. In certain embodiments, the performance modifier includes at least one of a silicone, a siloxane, and a wax. In certain embodiments, the performance modifier includes a polymethylhydrogen siloxane fluid. In certain embodiments, the coating composition includes 0.2% to 2.0% by weight of the performance modifier. In certain embodiments, the coated nonwoven mat has an average hydrostatic head performance of between 10 mbar to 50 mbar.

In certain embodiments, the nonwoven base layer has an uncoated basis weight of 65 g/m² to 75 g/m². In certain embodiments, the coated nonwoven mat includes a basis weight of 50 g/m² to 200 g/m². In certain embodiments, the coated nonwoven mat includes an average Gurley porosity of at least 100 seconds. In certain embodiments, the fibers include glass fibers. In certain embodiments, a gypsum board having at least one facer is provided, wherein the at least one facer includes a coated nonwoven mat made according to the method as described herein. In certain embodiments, a polyisocyanurate foam board having at least one facer is provided, wherein the at least one facer includes a coated nonwoven mat according to any of the embodiments herein.

A nonwoven mat is described herein, and in accordance with various embodiments, may include a nonwoven base layer and a coating composition. The nonwoven base layer is formed from a plurality of fibers held together by a binder and includes a first surface and a second surface. The coating composition is applied to one of the first surface or the second surface and extends at least partially into a thickness of the nonwoven base layer. The coating composition includes a binder component, a filler, and one or more performance modifiers. In certain embodiments, the nonwoven mat has an average Gurley porosity of at least 10 seconds and an average hydrostatic head performance of at least 10 mbar.

In certain embodiments, the coating composition includes a binder component in an amount from 2% to 20% by weight. In certain embodiments, the coating composition includes a filler in an amount from 65% to 99% by weight. In certain embodiments, the coating composition includes one or more performance modifiers in an amount from 0.05% to about 5.0% by weight. In certain embodiments, the performance modifier includes a hydrophobic additive. In certain embodiments, the performance modifier includes at least one of a silicone, a siloxane, and a wax. In certain embodiments, the performance modifier includes a polymethylhydrogen siloxane fluid. In certain embodiments, the coating composition includes 0.2% to 2.0% by weight of the performance modifier.

In any of the exemplary embodiments, the nonwoven mat may have an average hydrostatic head performance of between 10 mbar to 50 mbar. In certain embodiments, the nonwoven base layer has an uncoated basis weight of 65 g/m² to 75 g/m². The nonwoven mat may include an average Gurley porosity of at least 100 seconds. In certain embodiments, the fibers include glass fibers. In certain embodiments, the nonwoven mat further comprises a second coating layer adhered to the first surface, wherein the second coating layer comprises a second coating composition. The second coating composition can include a binder component in an amount from 2% to 20% by weight, a filler in an amount from 65% to 99% by weight, and one or more performance modifiers in an amount from 0.05% to about 5.0% by weight. In certain embodiments, a gypsum board having at least one facer is provided, wherein the at least one facer includes a nonwoven mat according to any of the embodiments herein.

### BRIEF DESCRIPTION OF THE DRAWINGS

The subject matter of the present disclosure is particularly pointed out and distinctly claimed in the concluding portion of the specification. A more complete understanding of the disclosure, however, may best be obtained by referring to the detailed description and claims when considered in connection with the figures, wherein like numerals denote like elements.

FIG. 1 illustrates a cross-sectional view of an exemplary embodiment of a coated nonwoven mat of the present disclosure.

FIG. 2 graphically illustrates the results of hydrostatic head pressure performance tests of a comparative coated nonwoven mat and two nonwoven mats coated in accordance with the present inventive concepts.

FIG. 3 graphically illustrates the Gurley porosity (in seconds) of a comparative coated nonwoven mat and two nonwoven mats coated in accordance with the present inventive concepts.

FIG. 4 graphically illustrates the L* color value of a comparative coated nonwoven mat and two nonwoven mats coated in accordance with the present inventive concepts.

### DETAILED DESCRIPTION

Unless otherwise defined, all technical and scientific terms used herein have the same meaning as commonly understood by one of ordinary skill in the art to which this application pertains. Although other methods and materials similar or equivalent to those described herein may be used in the practice or testing of the exemplary embodiments, exemplary suitable methods and materials are described below. In case of conflict, the present specification including definitions will control. In addition, the materials, methods, and examples are illustrative only and not intended to be limiting of the general inventive concepts.

The terminology as set forth herein is for description of the exemplary embodiments only and should not be construed as limiting the application as a whole. Unless otherwise specified, “a,” “an,” “the,” and “at least one” are used interchangeably. Furthermore, as used in the description of the application and the appended claims, the singular forms “a,” “an,” and “the” are inclusive of their plural forms, unless contradicted by the context surrounding such.

Unless otherwise indicated, all numbers expressing quantities used in the specification and claims are to be understood as being modified in all instances by the term “about.” The term “about” means within +/−10% of a value, or in some instances, within +/−5% of a value, and in some instances within +/−1% of a value.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” Thus, use of the term “or” herein is the inclusive, and not the exclusive use.

The coating compositions of the present disclosure can comprise, consist of, or consist essentially of the essential elements of the disclosure described herein, as well as any additional or optional elements described herein, or which are otherwise useful in coating compositions.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein may be performed in any order, unless otherwise specified or clearly implied to the contrary by the context in which the referenced combination is made.

The terms “binder,” “binder composition,” and “curable composition,” as used herein, are used interchangeably and refer to a material that holds one or more components of a nonwoven article together. Those of ordinary skill in the art will understand that a binder composition is often an aqueous mixture or solution of dissolved ingredients that cures to interconnect fibers together.

The terms “binder solids” or “binder components,” as used herein, are used interchangeably and refer to the functional ingredients of the binder composition prior to addition or mixing with water to form the ultimate binder for application to the inorganic fibers.

The terms “nonwoven,” “mat,” “veil,” and “facer” are used interchangeably herein and refer to a bound web of fibers.

While the general inventive concepts are susceptible of embodiment in many different forms, there are shown in the drawings, and will be described herein in detail, specific embodiments thereof with the understanding that the present disclosure is to be considered as an exemplification of the principles of the general inventive concepts. Accordingly, the general inventive concepts are not intended to be limited to the specific embodiments illustrated herein.

The general inventive concepts relate to coated and/or impregnated nonwoven mats. Although the mats are described herein as being coated, it is to be appreciated that the subject mats may alternatively be impregnated with the coating composition, or impregnated and subsequently coated. The coated nonwoven mats can include a coating composition deposited on the mats that can result in reduced defects, such as pinholes, such that the coating composition demonstrates reduced bleed-through of liquid materials applied to the mats. The coating composition may be deposited onto a nonwoven base layer as a part of a coating layer. The nonwoven base layer can be formed from a plurality of fibers held together by a binder. In some exemplary embodiments, the coating layer provides an impervious (e.g., water impervious), or substantially impervious barrier such that when a material, particularly a liquid material, is applied to a surface of the coated or impregnated nonwoven mat opposite the coating layer, the material is at least partially hindered from passing through the coated nonwoven mat by the coating layer. However, in some exemplary embodiments, the coating layer still allows moisture to escape during the manufacturing process.

The present inventive concepts are directed to the discovery that particular performance modifiers may be incorporated into the coating composition in a particularly balanced concentration can have an unexpectedly positive impact on the properties of a coated nonwoven mat, such as allowing for improved coating uniformity and water resistance, as measured by the hydrostatic head pressure performance, while also providing the ability to simultaneously tune and maintain a sufficient Gurley porosity.

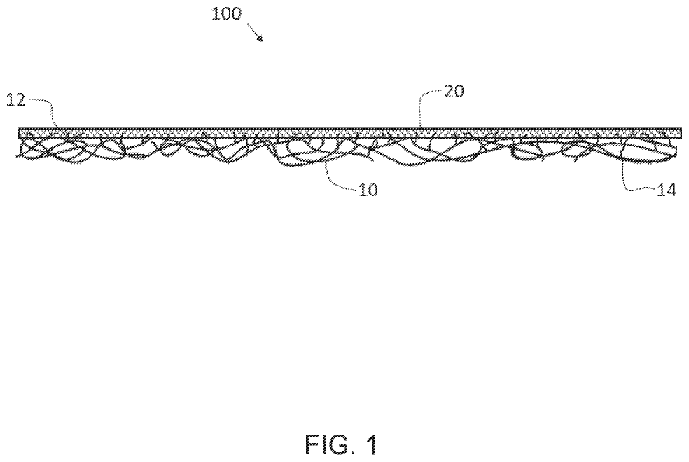

FIG. 1 provides an exemplary coated nonwoven mat 100. The coated nonwoven mat 100 comprises a nonwoven base layer 10 having a first surface 12 and an opposing second surface 14. The nonwoven base layer 10 of the present disclosure may be formed by a variety of processes, including wet-laid processes and dry-laid processes. In certain embodiments, the nonwoven base layer 10 is formed by a wet-laid process, which involves forming an aqueous slurry of discrete fibers in a mix tank filled with various components (sometimes referred to as white water), such as water, surfactants, viscosity modifiers, defoaming agents, lubricants, biocides, and/or other chemical agents. Agitation of the white water promotes dispersion of the fibers (e.g., chopped glass fibers) therein, to form a chopped glass fiber slurry. It is desirable that the slurry is agitated sufficiently to achieve a uniform or nearly uniform dispersion of the fibers.

The aqueous fiber dispersion or slurry may then be processed into a wet-laid mat according to any number of conventional methods known in the art. For example, the aqueous fiber slurry is deposited onto a moving screen or conveyor, on which the majority of the water drains through, leaving a randomly oriented fiber web. The fiber web may be further dried by a vacuum slot or other drying means. A binder composition may then be applied to the fiber web in a conventional manner, such as by curtain coating, spraying, twin wire dip bath, two roll padder, and the like. Water and excess binder composition may then be removed by a vacuum or other water removal means.

Finally, the fiber product may be dried and cured in one or more ovens. An exemplary temperature range for drying is from 350° F. (177° C.) to 600° F. (316° C.). The dried and cured product is the finished nonwoven base layer 10.

The nonwoven base layer 10 of the present disclosure may be formed from a variety of materials. In general, the nonwoven base layer 10 comprises a plurality of fibers and a binder composition that binds the fibers together. Exemplary fibers for forming the nonwoven base layer 10 include, but are not limited to, glass fibers, synthetic fibers (e.g., polyester fibers, polyethylene fibers, polypropylene fibers, polyethylene terephthalate fibers, polyamide fibers, aramid fibers, polyaramid fibers), mineral fibers, carbon fibers, ceramic fibers, natural fibers (e.g., cellulose fibers, cotton fibers, jute fibers, bamboo fibers, ramie fibers, bagasse fibers, hemp fibers, coir fibers, linen fibers, kenaf fibers, sisal fibers, flax fibers, henequen fibers), or a blend of two or more different types of fibers.

In certain embodiments, the nonwoven base layer 10 comprises glass fibers. The glass fibers can be made from any type of glass. Exemplary glass fibers include, but are not limited to, A-type glass fibers, C-type glass fibers, E-type glass fibers, S-type glass fibers, ECR-type glass fibers (e.g., Advantex® glass fibers commercially available from Owens Corning of Toledo, Ohio), Hiper-tex® glass fibers, high-performance (i.e., high modulus and/or tensile strength) glass fibers, wool glass fibers, and combinations thereof.

The glass fibers used to form the nonwoven base layer 10 may have a variety of fiber diameters. In certain embodiments, the glass fibers used to form the nonwoven base layer 10 have an average fiber diameter of 5.5 microns to 20 microns. In certain embodiments, the glass fibers used to form the nonwoven base layer 10 have an average fiber diameter of 3 microns to 18 microns. In certain embodiments, the glass fibers used to form the nonwoven base layer 10 have an average fiber diameter of 6 microns to 16 microns. In certain other embodiments, the glass fibers used to form the nonwoven base layer 10 have an average fiber diameter of 11 microns to 13 microns. It is also contemplated that a blend of glass fibers having different fiber diameters, such as a blend of smaller diameter glass fibers (e.g., average fiber diameter of 5.5 microns to 10 microns) and larger diameter glass fibers (e.g., average fiber diameter of 13 microns to 16 microns), may be used to form the nonwoven base layer 10.

The glass fibers used to form the nonwoven base layer 10 may also have a variety of fiber lengths. In certain embodiments, the glass fibers used to form the nonwoven base layer 10 have an average fiber length of 6.35 mm to 50.8 mm. In certain embodiments, the glass fibers used to form the nonwoven base layer 10 have an average fiber length of 12.7 mm to 38.1 mm. In certain other embodiments, the glass fibers used to form the nonwoven base layer 10 have an average fiber length of 19.05 mm to 25.4 mm. It is also contemplated that a blend of glass fibers having different fiber lengths, such as a blend of shorter glass fibers (e.g., average fiber length of 6.35 mm to 12.7 mm) and longer glass fibers (e.g., average fiber length of 19.05 mm to 31.75 mm), may be used to form the nonwoven base layer 10.

As mentioned above, the nonwoven base layer 10 also includes a binder composition to bind the fibers of the nonwoven base layer 10 together. Any conventional binder composition used to form nonwoven mats may be used to form the nonwoven base layer 10 of the present disclosure. In certain embodiments, the nonwoven base layer 10 comprises from 1% to 30% by weight binder composition, based on the total weight of the nonwoven base layer 10. In certain embodiments, the nonwoven base layer 10 comprises from 5% to 27% by weight binder composition, including from 10% to 25% by weight binder composition, and also including from 15% to 23% by weight binder composition, based on the total weight of the nonwoven base layer 10. As one of skill in the art will appreciate, the amount of binder composition used to form the nonwoven base layer 10 may be determined by measuring loss on ignition.

In any of the exemplary embodiments, the binder composition comprises a binder resin material, a coupling agent, and one or more optional additives. The binder resin may be a thermoset material, a thermoplastic material, or a mixture of a thermoset material and a thermoplastic material. In some exemplary embodiments, the binder resin material comprises any of an acrylic material, styrene-acrylic material, styrene butadiene, vinyl alcohol, a urea formaldehyde material, a melamine formaldehyde material, or a combination of the two materials. In some exemplary embodiments, the acrylic material is polyacrylic acid, such as low molecular weight polyacrylic acid with a weight average molecular weight at or below 10,000 Daltons.

In any of the exemplary embodiments, the binder resin may be present in the binder composition in an amount of 90% to 99% based on the total weight of the binder composition. In certain other embodiments, the binder resin may be present in the binder composition in an amount of 97% to 99% based on the total weight of the binder composition.

The binder composition may further include a coupling agent. It is to be appreciated that the coupling agents described herein are exemplary in nature, and any suitable coupling agent known to those of ordinary skill in the art may be utilized in any of the exemplary embodiments described or otherwise suggested herein. In certain embodiments, the coupling agent, or coupling agents, may be present in the binder composition in an amount of 0.05% to 10% based on the total weight of the binder composition. In certain embodiments, the coupling agent, or coupling agents, may be present in the binder composition in an amount of 0.1% to 3% based on the total weight of the binder composition. In certain embodiments, the coupling agent, or coupling agents, may be present in the binder composition in an amount of 0.15% to 0.5% based on the total weight of the binder composition.

In certain embodiments, at least one of the coupling agents is a silane coupling agent. Suitable silane coupling agents may include silanes containing one or more nitrogen atoms that have one or more functional groups such as amine (primary, secondary, tertiary, and quaternary), amino, imino, amido, imido, ureido, or isocyanato. Suitable silane coupling agents may also include, but are not limited to, aminosilanes, silane esters, vinyl silanes, methacryloxy silanes, epoxy silanes, sulfur silanes, ureido silanes, and isocyanato silanes. Specific, non-limiting examples of silane coupling agents for use in the instant invention include γ-methacryloxypropyl-trimethoxysilane (A-174), γ-aminopropyltriethoxysilane (A-1100), n-phenyl-γ-aminopropyltrimethoxysilane (Y-9669), n-trimethoxy-silyl-propyl-ethylene-diamine (A-1120), methyl-trichlorosilane (A-154), γ-chloropropyl-trimethoxy-silane (A-143), vinyl-triacetoxysilane (A-188), and methyltrimethoxysilane (A-1630).

The binder composition used to form the nonwoven base layer 10 of the present disclosure may optionally include additional components such as, for example, dyes, oils, fillers, colorants, aqueous dispersions, UV stabilizers, lubricants, wetting agents, surfactants, viscosity modifiers, and/or antistatic agents. Such additives may be included in the binder composition in an amount of 0% percent to 10% based on the total weight of the binder composition.

In certain embodiments, the binder composition used to form the nonwoven base layer 10 of the present disclosure may include water to dissolve or disperse the functional components for application onto the fibers. Water may be added in an amount sufficient to dilute the aqueous binder composition to a viscosity that is suitable for its application to the fibers.

The nonwoven base layer 10 of the present disclosure may have a wide range of basis weights (uncoated). In any of the exemplary embodiments, the nonwoven base layer 10 may have an uncoated basis weight of 25 g/m² to 300 g/m². In certain exemplary embodiments, the nonwoven base layer 10 has an uncoated basis weight of 30 g/m² to 200 g/m². In still other exemplary embodiments, the nonwoven base layer 10 has an uncoated basis weight of 40 g/m2 to 150 g/m², including an uncoated basis weight of 50 g/m² to 100 g/m², an uncoated basis weight of 55 g/m² to 80 g/m², and also including an uncoated basis weight of 65 g/m² to 75 g/m². In still other embodiments, the nonwoven base layer 10 has an uncoated basis weight of 68 g/m² to 73 g/m².

The nonwoven base layer 10 of the present disclosure may also have a variety of thicknesses. In certain exemplary embodiments, the nonwoven base layer 10 has a thickness of 0.25 mm to 2 mm. In certain other embodiments, the nonwoven base layer 10 has a thickness of 0.3 mm to 0.7 mm. In still other embodiments, the nonwoven base layer 10 has a thickness of 0.3 mm to 0.6 mm. In certain embodiments, the nonwoven base layer 10 has a thickness of 0.75 mm to 2 mm, including a thickness of 1 mm to 2 mm, a thickness of 1.25 mm to 1.9 mm, and also including a thickness of 1.5 mm to 1.8 mm.

Referring again to FIG. 1, the coated nonwoven mat 100 includes a coating layer 20 comprising a coating composition adhered to the first surface 12 of the nonwoven base layer 10. The coating layer 20 is preferably applied to the first surface 12 of the nonwoven base layer 10 using a coating process, as described in further detail below.

As seen in FIG. 1, the coating layer 20 extends partially into the nonwoven base layer 10 (i.e., partially through a thickness of the nonwoven base layer 10 measured from the first surface 12 to the second surface 14). In certain embodiments, the coating layer 20 may extend into the nonwoven base layer 10 in an amount of up to 75% of the thickness of nonwoven base layer 10 (measured from the first surface 12 to the second surface 14). In certain embodiments, the coating layer 20 may extend into the nonwoven base layer 10 in an amount of up to 50% of the thickness of nonwoven base layer 10 (measured from the first surface 12 to the second surface 14). In certain embodiments, the coating layer 20 may extend into the nonwoven base layer 10 in an amount of 10% to 50% of the thickness of nonwoven base layer 10 (measured from the first surface 12 to the second surface 14), and also including from 5% to 25% of the thickness of nonwoven base layer 10 (measured from the first surface 12 to the second surface 14). In certain embodiments, the second surface 14 of the nonwoven base layer 10 is free of a coating composition. It should be appreciated that the thickness to which the coating layer 20 extends into the nonwoven base layer 10 may vary somewhat along the width and/or length of the nonwoven base layer 10.

The coating layer 20 comprises a coating composition that includes a polymeric binder component and optionally a filler component (or “filler”), which may also be referred to as a mineral pigment. Suitable polymeric binders may include latex binders. Exemplary polymeric binders include one or more polymers selected from acrylic latex, styrene-butadiene-rubber (SBR), styrene-butadiene-styrene (SBS), ethylene-vinyl-chloride (EVCl), poly-vinylidene-chloride (PVdC), modified poly-vinyl-chloride (PVC), poly-vinyl-alcohol (PVOH), ethylene-vinyl-acetate (EVA), and poly-vinyl-acetate (PVA). In one or more embodiments, the polymeric binder is a polymer or copolymer of acrylic acid, methacrylic acid, acrylates, methacrylates, acrylonitrile, vinyl versatate, and combinations thereof. In one or more embodiments, the amount of polymeric binder in the coating composition may be described as a percent weight of coating binder based on the weight of the total solids (the non-water portion of the coating composition) in the coating composition. In one or more embodiments, the coating composition may include about 2% to about 20% polymeric binder, in other embodiments, about 4% to about 15% polymeric binder, about 5% to about 10% polymeric binder, and in other embodiments about 5.5% to about 8.0% polymeric binder based on the weight of the total solids in the coating composition.

Exemplary fillers suitable for making coated mats include, but are not limited to, ground limestone (calcium carbonate), clay (kaolin), sand, mica, talc, gypsum (calcium sulfate dihydrate), aluminum trihydrate (ATH), vermiculite, antimony oxide, micronized rubber, or a combination of any two or more of these substances. The amount of filler in the coating composition may be described as a percent weight of filler based on the weight of the total solids (the non-water portion of the coating composition) in the coating composition. In one or more embodiments, the coating composition may include about 65% to about 99% filler, in other embodiments, about 75% to about 98% filler, in other embodiments about 80% to about 97% filler, and in other embodiments, about 85% to about 95% filler, based on the weight of the total solids in the coating composition.

The coating composition may be an aqueous coating composition. In these or other embodiments, the amount of water in the coating composition may be described as a percent weight of water based on the weight of the total solids (the non-water portion of the coating composition) in the coating composition. In one or more embodiments, the coating composition may include about 15% to about 60% water, in other embodiments about 20% to about 50% water, and in other embodiments about 30% to about 40% water, based on the weight of the total solids in the coating composition.

The coating composition of the present disclosure may optionally include one or more additives. Exemplary additives include, but are not limited to, fire retardants, dyes, pigments, colorants, UV stabilizers, anti-static agents, film forming agents, dispersants, defoamers, biocides, viscosity modifiers, and so forth. Exemplary dispersants include sodium polyacrylate, ammonium polyacrylate, sodium salt of an acrylic copolymer, potassium salt of an acrylic copolymer, ammonium salt of an acrylic copolymer, polyalkoxylated copolymer, nonionic copolymers, and mixtures thereof. In any of the exemplary embodiments, the dispersant may be present in the coating composition in an amount from 0.01% to about 2.0%, or from about 0.05% to about 1.5%, or from about 0.08% to about 1.0%, or from about 0.1% to about 0.8%, based on the weight of the total solids in the coating composition.

As mentioned above, the coating composition may further include a biocide. Exemplary biocides include diiodomethyl-p-tolylsulfone, glutarealdehyde, isothiazolin, zinc oxide, zinc omadine, and silver. An exemplary biocide includes Amical™ Flowable (available commercially from DuPont). In some exemplary embodiments, the biocide is present in the coating composition in an amount from 0.01 wt. % to 1.0 wt. %, including between 0.05 wt. % to 0.25 wt. %, based on the total weight of the solids in the coating composition.

The coating composition may further include at least one viscosity modifier. Exemplary viscosity modifiers include polyacrylamide, anionic polyacrylate, anionic polyacrylamide copolymer, nonionic polyether, nonionic hydrophobically modified polyethylene oxide urethane copolymer, hydrophobically modified cellulose ethers, hydrophobically modified alkali swellable emulsion (HASE/ASE type), and hydrophobically modified ethoxylated urethane (HEUR). In some exemplary embodiments, the viscosity modifier is present in the coating composition in an amount from about 0.01 wt. % to about 5.0 wt. %, including between about 0.05 wt. % to about 2.0 wt. %, between about 0.1 wt. % and 1.5 wt. %, and between about 0.15 and 0.5 wt. %, based on the total weight of the solids in the coating composition.

As mentioned above, it has surprisingly been discovered that incorporating particular performance modifiers into the coating composition improves the hydrostatic head pressure performance of a coated mat, while also providing the ability to tune the mat's Gurley porosity to a desired degree. The performance modifiers may include hydrophobic additives, such as, for example, silicones, siloxanes, and/or waxes. Exemplary siloxanes can include a polymethylhydrogen siloxane fluid (such as Dowsil™ MH1107 or DF1040 from Momentive™ Performance Materials). Exemplary silicones may comprise reactive silicones, such as a modified silicone oil, hydrogen siloxanes, and/or silicone waxes. In any of the exemplary embodiments, the coating composition may include about 0.05% to about 5.0% of the performance modifier(s), including about 0.1% to about 2.0%, and about 0.25% to about 1.0%, based on the weight of the total solids in the coating composition.

In any of the exemplary embodiments, the coating composition may comprise the following:

TABLE 1
Exemplary Coating Compositions

| | Exemplary | Exemplary | Exemplary |
|---|---|---|---|
| | Composition A | Composition B | Composition C |
| | Dry Fraction | Dry Fraction | Dry Fraction |
| Functionality | (wt. %) | (wt. %) | (wt. %) |
| Filler | 80%-95% | 88%-92% | 90%-91% |
| Dispersant | 0.05%-0.25% | 0.08%-0.2% | 0.10%-0.15% |
| Binder | 3.0%-15.0% | 5.0%-9.0% | 6.5%-8.0% |
| Colorant | 0.5%-2.0% | 0.75%-1.5% | 1.0%-1.2% |
| Performance | 0.05%-5.0% | 0.1%-2% | 0.5%-1.5% |
| modifier | | | |
| Defoamer | 0%-0.5% | 0.01%-0.1% | 0.025%-0.075% |
| Biocide | 0%-0.50% | 0.01%-0.1% | 0.040%-0.080% |
| Viscosity | 0.01%-0.5% | 0.05%-0.25% | 0.100%-0.160% |
| modifier | | | |

The coated nonwoven mats 100 of the present disclosure includes a coating layer 20, which functions to substantially reduce defects, such as pinholes, thereby preventing bleed-through of a liquid/flowable material during manufacture of a construction board, such as a gypsum or polyisocyanurate boards, while still allowing moisture vapor to escape. The coated nonwoven mat 100 of the present disclosure includes a second, uncoated surface that is porous and permits wetting or penetration by the same liquid/flowable material.

Conventionally, the Gurley measurement method has been used as a predictive tool for assessing whether a coated mat would function to sufficiently inhibit bleed-through, while allowing moisture vapor to nonetheless escape during the manufacturing process. However, recently the consideration is shifting to hydrostatic head pressure performance, which is thought to detect more large defects, such as pinholes. Accordingly, while Gurley porosity relates to the overall openness of a mat (i.e., the lower the Gurley, the higher the “openness” of the mat), hydrostatic head pressure relates to the local openness (meaning that the presence of one large pinhole would lower the hydrostatic head pressure performance, regardless of the overall Gurley).

It has been surprisingly discovered that the inclusion of one or more of the performance modifiers disclosed herein provides improved coating uniformity and water resistance, which improves the mat's hydrostatic head pressure performance, without negatively effecting the air permeability of the mat, as measured by the Gurley method. Including or adjusting the amounts of certain performance modifiers in the coating composition can adjust the hydrostatic head pressure performance relative to the Gurley porosity, and including/adjusting the amounts of certain modifiers can adjust the Gurley porosity relative to the hydrostatic head pressure performance. As such, if a desired hydrostatic head pressure performance and Gurley porosity of a coated nonwoven mat are known, then the types and amounts of certain performance modifiers can be included or adjusted so that the properties can be obtained.

In any of the exemplary embodiments, including at least 0.05 wt. % of one or more of the performance modifiers increases the hydrostatic head pressure of a coated nonwoven mat to at least 10 mbar, including an average hydrostatic head pressure of at least 11 mbar, or at least 12 mbar, or at least 15 mbar, or at least 20 mbar. In any of the exemplary embodiments, the coated nonwoven mat may have a hydrostatic head pressure from 10 mbar to 50 mbar, including from 12 mbar to 40 mbar, 15 mbar to 30 mbar, and 15 mbar to 25 mbar. Hydrostatic head pressure is a measure of the resistance of a mat to penetration by liquid water under a static load. A sample (e.g., a 3″ diameter circle) is mounted in a TEXTEST FX 3000 Hydro-Tester IV, model 4M Hydrostatic Head Tester. Water is pumped against one side of a section of the sample until three areas of the sample are penetrated by the water. The test generally follows AATCC-127 or IOS811. In other words, hydrostatic head pressure is a measure of a substrate's water permeability. In various embodiments, the parameters of the Hydrostatic Head Tester are set such that the gradient is 60 mbar/min, the test area is 100 cm², the stop criterion is set to third drop, and the air pressure at the regulator is 90 PSI (which can register as 4 bar at the tester).

Effective coated nonwoven mats may be free or substantially free of liquid bleed-through, while still allowing moisture to escape from the gypsum core during the manufacturing process. By “substantially free” it is meant that the coated nonwoven mat allows less than 10% of a liquid material to bleed-through a 3″ diameter circle of the mat, including less than 8%, less than 5%, less than 3%, less than 1%.

Simultaneously, the amount of performance modifier is included such that it will not negatively impact the overall Gurley porosity. Gurley porosity is a measure of air permeability through the air flow rate. It may be measured in accordance with TAPPI T-460 (Gurley method), or similar methods. This test measures the time required for 100 cubic centimeters of air to be pushed through an approximately 6.45 cm² (1 in²) circular area of sample under a pressure of approximately 1.22 kPa. The result is expressed in seconds and is frequently referred to as Gurley seconds. As the Gurley porosity increases, permeability decreases, and as Gurley porosity decreases, permeability increases. The coated nonwoven mat 100 of the present disclosure can have an average Gurley porosity of at least 10 seconds, including an average Gurley porosity of at least 20 seconds, at least 30 seconds, at least 40 seconds, and at least 100 seconds. In certain embodiments, the coated nonwoven mat 100 of the present disclosure can have an average Gurley porosity of at least 100 seconds, including an average Gurley porosity of at least 200 seconds, at least 300 seconds, at least 400 seconds, and at least 1,000 seconds.

The coating composition of the present disclosure may also have a variety of viscosities. In certain embodiments, the coating composition has a viscosity of 250 cP (centipoise) to 25,000 cP, including, for example, viscosities of 500 cP to 20,000 cP, 1000 cP to 15,000 cP, 5000 cP to 10,000 cP, and 7000 cP to 8,000 cP, including all endpoints and subranges therebetween.

The coating layer 20 of the present disclosure may be applied in a wide range of coat weights. In any of the exemplary embodiments, the coating layer 20 may have a coat weight of 25 g/m² to 400 g/m², including, for example 40 g/m² to 300 g/m², 30 g/m² to 150 g/m², 50 g/m² to 80 g/m², and 65 g/m² to 100 g/m², including all endpoints and subranges therebetween.

The coating layer 20 of the present disclosure may have a variety of thicknesses. In any of the exemplary embodiments, the coating layer 20 may have a thickness of 1 micron to 500 microns, including, for example, a thickness of 5 microns to 250 microns, 10 microns to 200 microns, and 50 microns to 100 microns.

The coating composition may be deposited onto a nonwoven base layer formed from a plurality of fibers held together by a binder. The coating composition may be deposited using a variety of methods. The coating composition may be deposited using methods including knife over plate via dipping bath or knife over roll via dipping bath. Other suitable methods include, but are not limited to, waterfall coating, curtain coating, fountain coating, immersion or impregnation coating, brush coating, and spray coating.

Once coated, the coated nonwoven mat 100 of the present disclosure may have a wide range of basis weights. In any of the exemplary embodiments, the coated nonwoven base layer 10 may have a basis weight of 50 g/m² to 200 g/m², including, for example, a basis weight of 65 g/m² to 180 g/m², 75 g/m² to 160 g/m², 100 g/m² to 150 g/m², and 115 g/m² to 125 g/m².

The amount of binder composition present in the coated nonwoven mats of the present disclosure may be determined by measuring loss on ignition (LOI). The coated nonwoven mat 100 of the present disclosure may have a wide range of LOI. In certain embodiments, the nonwoven base layer 10 has a LOI of 10%-70%. In certain embodiments, the coated nonwoven mat 100 has a LOI of 25%-60%. In certain embodiments, the coated nonwoven mat 100 has a LOI of 30%-50%. In certain embodiments, the coated nonwoven mat 100 has a LOI of 40%-45%.

Owing to its two different surfaces (i.e., the coated surface and the uncoated, porous surface), the coated nonwoven mat 100 of the present disclosure may be used in a variety of applications and products. In on one or more embodiments, the coated nonwoven mat 100 may be used as a precoated facer in a construction board, such as, for example, gypsum board, polymeric foam board, or cement board.

As indicated above, the coated nonwoven mat 100 includes a first side and a second side, opposite the first side. In one or more embodiments, a construction board may be attached or bound to the second side of the coated nonwoven mat 100. The construction board has the coated nonwoven mat 100 situated on one side of the construction board and the construction board has an opposing side opposite the coated nonwoven mat 100. In one or more embodiments, the opposing side of the construction board may have a second facer that is the same or different than the coated nonwoven mat 100. In one or more embodiments, the second facer is a paper facer, coated paper facer, foil facer, fiber facer, conventional coated fiber facer, or a second coated nonwoven mat, formed in accordance with the present disclosure. In other embodiments, the opposing side of the construction board may not have a facer.

In any of the exemplary embodiments, the coated nonwoven mat 100 may be included in the production of a gypsum board. The gypsum board includes a gypsum core with two opposing sides and at least one coated nonwoven mat situated on one of the opposing sides. Wall boards formed of a gypsum core sandwiched between facing layers are commonly used in the construction industry as internal walls and ceilings for both residential and commercial buildings. Formulations and the design of the gypsum board may be tailored for the specific use desired for the board. In one or more embodiments, the gypsum core includes gypsum, optionally wet chopped glass fibers, water resistant chemicals, binders, accelerants, and low-density fillers. In one or more embodiments, the gypsum board may be prepared by providing a continuous layer of the coated nonwoven mat and depositing a gypsum slurry onto one surface of the coated nonwoven mat (typically the side opposite the coating composition). A second continuous layer of facing material (either the coated nonwoven mat 100 or a different facing material) can be applied to the opposite surface of the gypsum slurry. In this manner, the gypsum slurry is sandwiched between opposing layers of facing material. The sandwiched gypsum slurry is then adjusted to a desired thickness and dried to harden the gypsum core and form a gypsum board. In other embodiments, the application of the second facer is omitted to prepare a board with a single facer. Next, the gypsum board may be cut to predetermined dimensions (e.g., length) for end use.

In one or more embodiments, the one or more coated nonwoven mats 100 for use on a wall board formed of a gypsum core can have an average Gurley porosity of at least 10 seconds, including an average Gurley porosity of at least 25 seconds, at least 80 seconds, at least 150 seconds, and at least 300 seconds. In one or more embodiments, the one or more coated nonwoven mat 100 may have an average Gurley porosity of between about 10 seconds and 100 seconds, including an average Gurley porosity between 20 seconds and 90 seconds, and between at least 25 seconds and 75 seconds.

In any of the exemplary embodiments, in a wall board formed of a gypsum core sandwiched between one or more of the coated nonwoven mats 100, including at least 0.05 wt. % of one or more of the performance modifiers increases the hydrostatic head pressure of the coated nonwoven mat to at least 10 mbar, including an average hydrostatic head pressure of at least 11 mbar, or at least 12 mbar, or at least 15 mbar, or at least 20 mbar. In any of the exemplary embodiments, the wall board formed of a gypsum core sandwiched between one or more of the coated nonwoven mat 100 has a hydrostatic head pressure from 10 mbar to 50 mbar, including from 12 mbar to 40 mbar, 15 mbar to 30 mbar, and 15 mbar to 25 mbar.

In one or more embodiments, the coated nonwoven mat 100 may be included in a polymeric foam board. The foam board includes a foam core with two opposing sides and at least one coated nonwoven mat 100 situated on one of the opposing sides. Suitable foams for use in the foam board include polyurethane, polystyrene, and polyisocyanurate foams. Polyisocyanurate and polyurethane foam compositions have three major components: a polyfunctional isocyanate compound, a polyol and a blowing agent. When these three components are mixed, along with small amounts of catalysts and surfactants, a heat-generating chemical reaction causes the liquid blowing agent to boil. The resultant blowing agent vapor expands the foam to create gas-filled cells.

In one or more embodiments, the one or more coated nonwoven mats for use with a polymeric foam core has an average Gurley porosity of at least 300 seconds, including an average Gurley porosity of at least 500 seconds, at least 750 seconds, at least 1,000 seconds, at least 1,250 seconds, and at least 1,500 seconds.

In any of the exemplary embodiments, in a polymeric foam including one or more of the coated nonwoven mat 100, including at least 0.05 wt. % of one or more of the performance modifiers increases the hydrostatic head pressure of the product to at least 10 mbar, including an average hydrostatic head pressure of at least 25 mbar, or at least 50 mbar, or at least 75 mbar, or at least 100 mbar. In any of the exemplary embodiments, the polymeric foam including one or more of the coated nonwoven mat 100 has a hydrostatic head pressure from 10 mbar to 100 mbar, including from 25 mbar to 80 mbar, 35 mbar to 70 mbar, and 45 mbar to 50 mbar, including all endpoints and subranges therebetween.

The addition of one or more performance additives may impact the color of the coating layer. Particularly, in any of the exemplary embodiments, the addition of between 0.5 wt. % and 5.0 wt. % of one or more performance additives lowers the coating layer's L* value, based on the L*a*b* color scale, such that the L* value is less than 45, such as, for example, less than 40, less than 37, and less than 35.

In one or more embodiments, the foam board may be described by the density of the foam material. In one or more embodiments, the foam board may have a density or an average density greater than 6 lbs/ft³. In these or other embodiments, the foam board has a density or an average density of about 6 lbs/ft³ to about 25 lbs/ft³, and in other embodiments about 8 lbs/ft³ to about 23 lbs/ft³. In other embodiments, the foam board may have a density or an average density less than 6 lbs/ft³. In other embodiments, the foam board has a density or an average density of about 1 lb/ft³ to about 6 lbs/ft³, and in other embodiments about 2 lbs/ft³ to about 5 lbs/ft³, or between 3 lb/ft³ to about 4 lbs/ft³. In another application, the coated nonwoven mat 100 of the present disclosure may be used as a substrate for forming roofing shingles or a roofing underlayment. The coating layer 20 of the coated nonwoven mat 100 will prevent bleed-through of the asphalt/bitumen, whereas the asphalt/bitumen can wet out and bond to the portion of the nonwoven base layer 10 that is uncoated.

In another application, the coated nonwoven mat 100 of the present disclosure may be used as a substrate in the manufacture of flooring materials. For example, flooring products such as carpet tiles and vinyl tiles may have a discontinuous or uneven layer of plastisol or polyvinyl chloride (PVC) on a backing of the tiles due to plastisol or PVC bleed-through in the manufacturing process. The coated nonwoven mat 100 of the present disclosure may be used as a backing or reinforcement for flooring materials that prevents plastisol or PVC bleed-through and provides a smooth surface (via the coating layer 20) and allows plastisol or PVC wetting (via the nonwoven material) to form a strong bond between the coated nonwoven mat 100 and other structural portions of the flooring material, while also providing the flooring material with good dimensional stability and mechanical performance. In another application, the coated nonwoven mat 100 of the present disclosure may be used as a substrate in the manufacture of tile backer boards, including waterproof or light weight polyisocyanurate tile backer boards.

The general inventive concepts further relate to a method of forming a coated nonwoven mat. The method of forming a coated nonwoven mat of the present disclosure comprises: a) depositing an aqueous fiber slurry onto a processing line to form a wet laid mat having a first major surface and a second major surface; b) applying a binder composition to at least one of the first major surface and the second major surface of the wet laid mat; and c) heating the wet laid mat to cure the binder composition, thereby forming the nonwoven mat. Any one or more of the fibers disclosed herein may be used in the methods of the present disclosure. In certain embodiments, the fibers are provided to a conveying apparatus such as a conveyor by a storage container for delivery to a mixing tank that contains various surfactants, viscosity modifiers, defoaming agents, and/or other chemical agents with agitation to disperse the fibers and to form an aqueous fiber slurry.

In accordance with the method of the present disclosure, the fiber slurry is deposited onto a processing line to form a wet laid mat having a first major surface and a second major surface. The processing line may be any suitable formation apparatus capable of forming a wet laid mat including, but not limited to, a moving screen or forming wire on an inclined wire forming machine, wire cylinders, Fourdrinier machines, Stevens former, Roto former, Inver former, or Venti former machines. While on the processing line, a substantial portion of the water from the fiber slurry is removed to form a wet laid mat of enmeshed, randomly oriented fibers. The water may be removed from the wet laid mat by a conventional vacuum or air suction system.

The method of the present disclosure also includes applying the binder composition to at least one of the first surface and the second surface of the wet laid mat. The binder composition may be any of the binder compositions previously described herein. The binder composition may be applied to the wet laid mat using a suitable application method including, but not limited to, a binder wire, a spray applicator, a curtain coater, and a Foulard applicator.

In accordance with the method of the present disclosure, after the binder composition is applied to the wet laid mat, the wet laid mat is heated to remove any residual water and cure the binder composition, thereby forming the nonwoven mat. The step of heating the wet laid mat may be accomplished using any known heating or drying method. Suitable heating methods that may be used in the method of the present disclosure include, but are not limited to, a rotary/thru air dryer or oven, a heated drum dryer, an infrared heating source, a hot air blower, and a microwave emitting source. In certain embodiments, the heating step comprises exposing the wet laid mat having the binder composition applied thereto to a temperature of 150° C. to 250° C. for a time period of up to 45 seconds.

In some exemplary embodiments, the method of making the coated nonwoven mat includes applying a coating layer including a coating composition to at least one of the first surface or the second surface of the nonwoven base layer to form a coated nonwoven mat. The coating composition may be applied to the nonwoven mat by conventional coating techniques such as spray coating, Meyer rod coating, slot die coating, blade/knife coating, forward roll coating, reverse roll coating, gravure coating, or curtain coating. The method of making the coated nonwoven mat also includes heating the coated nonwoven mat, thereby forming a finished coated nonwoven mat. The step of heating the coated nonwoven mat can take place in one or more ovens. An exemplary temperature range for drying is from 350° F. (177° C.) to 600° F. (316° C.). The step of heating the coated nonwoven mat can also include melting the coating composition onto the nonwoven base layer, allowing the coating composition to flow and create a more tightly sealed coating with lower porosity.

In some exemplary embodiments, the method of making the coated nonwoven mat includes impregnating a nonwoven fiber mat with the coating composition, forming an impregnated nonwoven facer. In certain exemplary embodiments, the coating composition fully impregnates the nonwoven fiber mat, such that the coating composition fully penetrates or at least substantially fully penetrates the thickness of the mat. By “substantially fully penetrates” it is meant that the coating composition penetrates at least 75% of the thickness of the nonwoven mat.

In some exemplary embodiments, the nonwoven fiber mats are impregnated with a first coating composition and then coated with a second coating composition. The first and second coating compositions may be the same or different compositions, described in more detail above. The process of impregnating the nonwoven fiber mats, followed by coating the mats may occur in-line, in continuous process or the impregnation and coating processes may occur in distinct processing steps. Regardless of process sequence, the impregnated nonwoven fiber mat is at least substantially fully cured and dried, prior to application of the second coating composition. In some exemplary embodiments, the impregnated nonwoven fiber mat is fully cured and dried, prior to application of the second coating composition.

### EXAMPLES

### Example 1

Various coated nonwoven mats were produced in a substantially identical manner, with the exception of the particular coating composition of the coating layer. Specifically, each of the coated nonwoven mats comprise a coating composition including, inter alia, about 90 to 91 weight percent solids of a calcium carbonate filler, about 0.1 to 0.2 weight percent solids of a surfactant, and about 7.0 to 8.0 weight percent solids of a vinyl ester acrylic polymer binder. The coating composition of Comparative Example 1 includes only a pigment (Pigment A); Example 1 included Pigment A and 0.5 wt. % of Performance Modifier A; and Example 2 included Pigment A and 0.5 wt. % of Performance Modifier B. Performance Modifier A is a methylhydrogen siloxane, commercially available from Momentive Performance Materials under the name DF1040 and Performance Modifier B is a polymethylhydrogen siloxane polymer, commercially available from Dow Chemical under the name Dowsil™ MH1107.

TABLE 2
Coating Compositions

| | Hydrostatic Head | Gurley |
|---|---|---|
| | Pressure (mbar) | (sec) |
| Comparative Example 1: Pigment A | 8.1 | 111.3 |
| Example 1: Pigment A + 0.5 wt. % | 12.2 | 100.1 |
| Performance Modifier A | | |
| Example 2: Pigment A + 0.5 wt. % | 13.1 | 35 |
| Performance Modifier B | | |

Hydrostatic head pressure performance tests and Gurley air permeation tests were performed on the mats. The hydrostatic head pressure performance tests were performed according to the AATCC 127-2008 test method using the TEXTEST FX 3000 Hydro-Tester IV, model 4M. The gradient selected was 60 mbar/min, test area was 100 cm², and the stop criterion was set to third drop. The air pressure at the regulator was set to 90 PSI, which registered as 4 Bar at the tester. The results of the hydrostatic head pressure performance tests and Gurley permeation tests are illustrated above in Table 2. The addition of Performance Modifier A to the coating composition of Example 1 increased the hydrostatic head pressure from 8.1 mbar to 12.2 mbar, and decreased Gurley from 111.3 seconds to 100.1 seconds. The addition of Performance Modifier B to the coating composition of Example 2 increased the hydrostatic head pressure from 8.1 mbar to 13.1 mbar, and decreased Gurley from 111.3 seconds to 35 seconds.

### Example 2

Various coated nonwoven mats were produced in a substantially identical manner, with the exception of the particular coating composition in the coating layer. Specifically, each of coated nonwoven mats comprise a coating composition including, inter alia, about 90 to 91 weight percent solids of a calcium carbonate filler, about 0.1 to 0.2 weight percent solids of a surfactant, and about 7.0 to 8.0 weight percent solids of a vinyl ester acrylic polymer binder. The coating composition of Comparative Example 2 included only a pigment (Pigment A); Example 2 included Pigment A and 0.5 wt. % of Performance Modifier A; and Example 3 included Pigment A and 0.5 wt. % of Performance Modifier B. Performance Modifier A is a methylhydrogen siloxane, commercially available from Momentive Performance Materials under the name DF1040 and Performance Modifier B is a polymethylhydrogen siloxane polymer, commercially available from Dow Chemical under the name Dowsil™ MH1107.

TABLE 3
Coating Compositions

| | Hydrostatic Head | Gurley |
|---|---|---|
| | Pressure (mbar) | (sec) |
| Comparative Example 2: Pigment B | 17.1 | 157 |
| Example 3: Pigment B + 0.5 wt. % | 25.7 | 84 |
| Performance Modifier A | | |
| Example 4; Pigment B + 0.5 wt. % | 24.9 | 44.3 |
| Performance Modifier B | | |

Hydrostatic head pressure performance tests and Gurley porosity tests were performed on the mats. The Hydrostatic head pressure performance tests were performed according to the AATCC 127-2008 test method using the TEXTEST FX 3000 Hydro-Tester IV, model 4M. The gradient selected was 60 mbar/min, test area was 100 cm², and the stop criterion was set to third drop. The air pressure at the regulator was set to 90 PSI, which registered as 4 Bar at the tester. The results of the hydrostatic head pressure performance tests and Gurley air permeation tests are illustrated above in Table 3. The addition of Performance Modifier A to the coating composition of Example 3 increased the hydrostatic head pressure from 17.1 mbar to 25.7 mbar, and decreased Gurley from 157 seconds to 84 seconds. The addition of Performance Modifier B to the coating composition of Example 4 increased the hydrostatic head pressure from 17.1 mbar to 24.9 mbar, and decreased Gurley from 157 seconds to 44.3 seconds.

### Example 3

Various coated nonwoven mats were produced in a substantially identical manner, with the exception of the particular coating composition in the coating layer. Specifically, each of coated nonwoven mats comprise a coating composition including, inter alia, about 90 to 91 weight percent solids of a calcium carbonate filler, about 0.1 to 0.2 weight percent solids of a surfactant, and about 7.0 to 8.0 weight percent solids of a vinyl ester acrylic polymer binder. The coating composition of Comparative Example 3; Example 5 included 0.5 wt. % of a reactive silicone performance modifier; and Example 6 included 2.5 wt. % of a reactive silicone performance modifier.

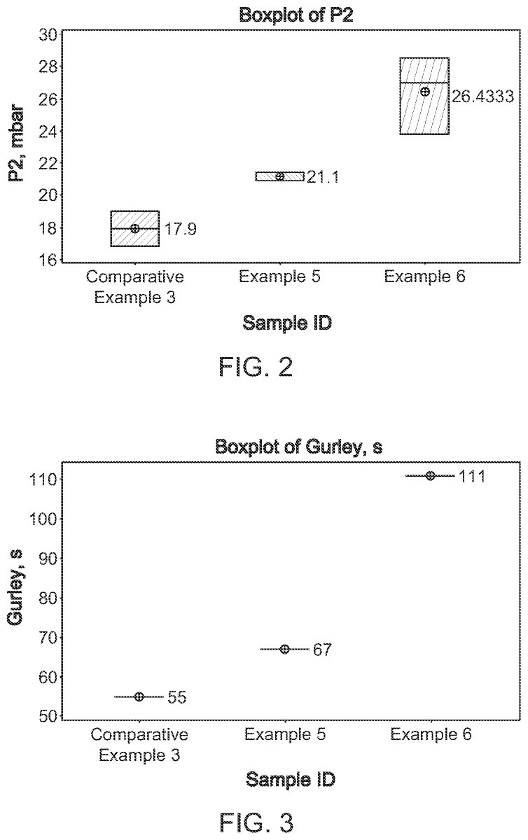

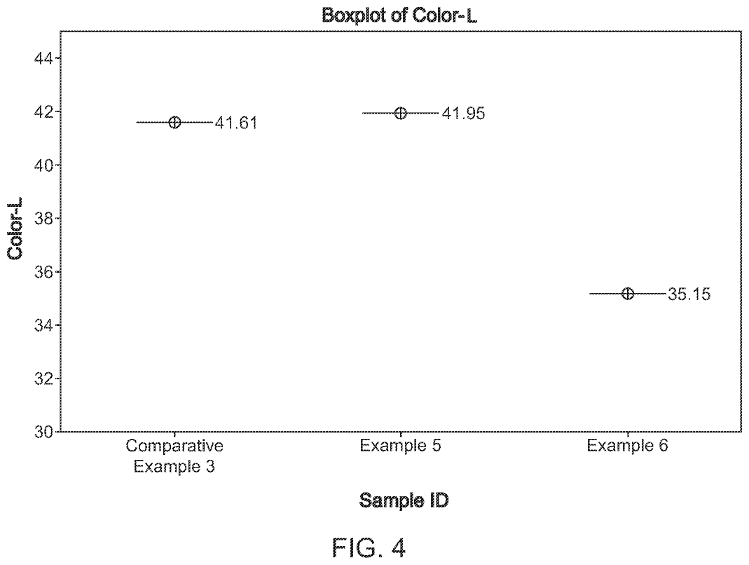

Hydrostatic head pressure performance tests and Gurley porosity tests were performed on the mats. The Hydrostatic head pressure performance tests were performed according to the AATCC 127-2008 test method using the TEXTEST FX 3000 Hydro-Tester IV, model 4M. The gradient selected was 60 mbar/min, test area was 100 cm2, and the stop criterion was set to third drop. The air pressure at the regulator was set to 90 PSI, which registered as 4 Bar at the tester. The results of the hydrostatic head pressure performance tests and Gurley air permeation tests are illustrated in FIGS. 2 and 3. The addition of 0.5 wt. % of a reactive silicone performance modifier increased the hydrostatic head pressure from 17.9 mbar to 21.1 mbar and increased the Gurley air permeation from 55 seconds to 67 seconds. Increasing the amount of reactive silicone to 2.5 wt. % causes the hydrostatic head pressure to 26.43 mbar and also increased the Gurley air permeation to 111 seconds. Additionally, as illustrated in FIG. 4, increasing the amount of reactive silicone to 2.5 wt. % causes the color of the coating to darken, resulting in a lower L* value on the L*a*b* color scale.

The method of the present disclosure may be used to make any of the various embodiments of coated nonwoven mats previously described herein. All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

The coated nonwoven mats of the present disclosure can comprise, consist of, or consist essentially of the essential elements and limitations of the disclosure as described herein, as well as any additional or optional components or limitations described herein or otherwise useful in nonwoven mat applications.

In some embodiments, it may be possible to utilize the various inventive concepts in combination with one another. Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

The scope of the general inventive concepts presented herein are not intended to be limited to the particular exemplary embodiments shown and described herein. From the disclosure given, those skilled in the art will not only understand the general inventive concepts and their attendant advantages, but will also find apparent various changes and modifications to the devices, systems, and methods disclosed. It is sought, therefore, to cover all such changes and modifications as fall within the spirit and scope of the general inventive concepts, as described and/or claimed herein, and any equivalents thereof.

What is claimed is:

1. A coated nonwoven mat comprising:
a nonwoven base layer formed from a plurality of fibers held together by a binder, the nonwoven base layer having a first surface and a second surface; and
a coating layer adhered to the first surface and extending partially into the nonwoven base layer, wherein the coating layer comprises a coating composition, wherein the coating composition comprises:
a binder component in an amount from 2% to 20% by weight,
a filler in an amount from 65% to 99% by weight, and
at least one performance modifier in an amount from 0.05% to about 5.0% by weight, wherein the performance modifier comprises a hydrophobic additive.
wherein the coated nonwoven mat has an average Gurley porosity of at least 10 seconds, and
wherein the coated nonwoven mat has an average hydrostatic head performance of at least 10 mbar.

2. The coated nonwoven mat of claim 1, wherein the performance modifier comprises at least one of a silicone, a siloxane, and a wax.

3. The coated nonwoven mat of claim 1, wherein the performance modifier comprises a polymethylhydrogen siloxane fluid.

4. The coated nonwoven mat of claim 1, wherein the performance modifier comprises a reactive silicone.

5. The coated nonwoven mat of claim 1, wherein the coating composition comprises 0.2% to 2.0% by weight of the performance modifier.

6. The coated nonwoven mat of claim 1, wherein the coated nonwoven mat has an average hydrostatic head performance of between 10 mbar to 50 mbar.

7. The coated nonwoven mat of claim 1, wherein the nonwoven base layer has an uncoated basis weight of 65 g/m² to 75 g/m².

8. The coated nonwoven mat of claim 1, wherein the coated nonwoven mat comprises a basis weight of 50 g/m² to 200 g/m².

9. The coated nonwoven mat of claim 1, wherein the coated nonwoven mat comprises a loss on ignition of 10%-70%.

10. The coated nonwoven mat of claim 1, wherein the coated nonwoven mat comprises an average Gurley porosity of at least 100 seconds.

11. The coated nonwoven mat of claim 1, wherein the coating layer has an L* value of less than 40, based on the L*a*b* color scale.

12. A gypsum board comprising at least one facer, wherein the at least one facer comprises a coated nonwoven mat according to claim 1.

13. A method of making a coated nonwoven mat, the method comprising:
providing a nonwoven base layer formed from a plurality of fibers held together by a binder, the nonwoven base layer having a first surface and a second surface;
applying a coating composition to the first surface of the nonwoven base layer to form a coating layer on the nonwoven base layer, wherein the composition comprises:
a binder component in an amount from 2% to 20% by weight,
a filler in an amount from 65% to 99% by weight, and
one or more performance modifiers in an amount from 0.05% to about 5.0% by weight, wherein the performance modifier comprises a hydrophobic additive, and heating the nonwoven base layer with the coating layer to form the coated nonwoven mat,
wherein the coated nonwoven mat has an average Gurley porosity of at least 10 seconds, and
wherein the coated nonwoven mat has an average hydrostatic head performance of at least 10 mbar.

14. The method of claim 13, wherein the coated nonwoven mat comprises an average Gurley porosity of at least 300 seconds

15. The method of claim 13, wherein the performance modifier comprises at least one of a silicone, a siloxane, and a wax.

16. The method of claim 13, wherein the performance modifier comprises a polymethylhydrogen siloxane fluid.

17. The method of claim 13, wherein the coated nonwoven mat has an average hydrostatic head performance of between 10 mbar to 50 mbar.

18. A nonwoven mat comprising:
a nonwoven base layer formed from a plurality of fibers held together by a binder, the nonwoven base layer having a first surface and a second surface; and
a coating composition applied to the second surface and extending at least partially into a thickness of the nonwoven base layer, wherein the coating composition comprises:
a binder component in an amount from 2% to 20% by weight,
a filler in an amount from 65% to 99% by weight, and
at least one performance modifier in an amount from 0.05% to about 5.0% by weight, wherein the performance modifier comprises a hydrophobic additive,
wherein the nonwoven mat has an average Gurley porosity of at least 10 seconds, and
wherein the nonwoven mat has an average hydrostatic head performance of at least 10 mbar.

19. The nonwoven mat according to claim 18, wherein the nonwoven mat further comprises a second coating layer adhered to the first surface, wherein the second coating layer comprises a second coating composition, wherein the second coating composition comprises:
a binder component in an amount from 2% to 20% by weight,
a filler in an amount from 65% to 99% by weight, and
one or more performance modifiers in an amount from 0.05% to about 5.0% by weight.

20. A gypsum board comprising at least one facer, wherein the at least one facer comprises a nonwoven mat according to claim 18.

21. A polyisocyanurate foam board comprising at least one facer, wherein the at least one facer comprises a nonwoven mat according to claim 1.

22. A polyisocyanurate foam board comprising at least one facer, wherein the at least one facer comprises a nonwoven mat according to claim 18.
